(19) United States
(12) Patent Application Publication
(10) Pub. No.: US 2006/0121382 A1
(43) Pub. Date: Jun. 8, 2006

(54) Electrophotographic developing agent

(75) Inventors: Seok-hoon Choi, Suwon-si (KR); Sang-deok Kim, Seoul (KR); Duck-hee Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/182,796

(22) Filed: Jul. 18, 2005

(30) Foreign Application Priority Data
Dec. 4, 2004 (KR) 10-2004-0101536

(51) Int. Cl. G03G 9/08

(52) U.S. Cl. 430/108.21; 430/108.7; 430/108.3

(57) ABSTRACT

An electrophotographic developing agent is provided including: toner particles including a binder resin, a colorant, and a charge control agent; and an external additive added to the surface of the toner particles, wherein the external additive includes a large particle diameter silica component having a mean primary particle diameter of 20 to 200 nm and surface treated with at least two different types of surface treatment agent; a small particle diameter silica component having a mean primary particle diameter of 5 to 20 nm and surface treated with at least two different types of surface treatment agent; and a hydrophobic strontium titanate. The electrophotographic developing agent includes the silcas that are surface treated with at least two different types of surface treatment agent and the hydrophobic strontium titanate as the external additive, thereby maintaining stable charge quantity and charge distribution in spite of environmental changes and long printing time to prevent fog and blurring.

### BACKGROUND OF THE INVENTION

This application claims priority from Korean Patent Application No. 10-2004-0101536, filed on Dec. 4, 2004, in the Korean Intellectual Property Office, the disclosure of which is incorporated herein by reference in its entirety.

1. Field of the Invention

The present invention relates to an electrophotographic developing agent. More particularly, the invention relates to an electrophotographic developing agent for maintaining a stable charge quantity and charge distribution to prevent fog and image contamination in a developing apparatus of an electrophotographic image processing device.

2. Description of the Related Art

Electrophotographic image processing devices such as laser printers, facsimile machines, copying machines, etc. are now widely used. These devices form a desired image by forming a latent image on a photoreceptor using a laser, moving toner onto the latent image using an electric potential difference, and then transferring the toner image onto a printing medium such as paper.

FIG. 1 illustrates an embodiment of a non-contact developing-type image forming apparatus.

In the non-contact developing-type image forming apparatus of FIG. 1, a non-magnetic one-constituent developing agent 8 is fed to a developing roller 5 by a feeding roller 6 including an elastic member, such as a polyurethane foam, sponge, and the like. As the developing roller 5 rotates, the developing agent 8 that is fed to the developing roller 5 arrives at a line of contact between a developing agent regulating blade 7 and the developing roller 5. The developing agent regulating blade 7 includes an elastic member which is made of metal, rubber, and the like. Only a thin layer of the developing agent 8 can pass between the developing agent regulating blade 7 and the developing roller 5. The thin layer of the developing agent on the developing roller is electrically charged. The thin layer of developing agent 8 is then rotated to a developing area 3 where it is transferred from the developing roller 5 to an electrostatic latent image formed on a photoreceptor 1.

The developing roller 5 and the photoreceptor 1 are separated by a predetermined distance and face each other. The developing roller 5 rotates counterclockwise and the photoreceptor 1 rotates clockwise. The developing agent 8 rotated to the developing area is transferred onto the electrostatic latent image of the photoreceptor 1 by force generated by an electric potential difference between the developing roller 5, to which a DC-offset AC voltage is applied by the voltage device 12, and the latent image formed on the photoreceptor 1.

As the photoreceptor 1 rotates, the developing agent 8 on the photoreceptor 1 arrives at a transfer means 9 and is transferred onto a printing paper 13 by the transfer means 9 to form an image. Here, the transfer means 9 may use a corona discharge or may have a roller form. The transfer means 9 is maintained at a high voltage of opposite polarity to the developing agent 8.

The image transferred to the printing paper 13 is fused onto the printing paper 13 by passing through a high-temperature and high-pressure fusing apparatus (not shown). Meanwhile, residual developing agent on the developing roller 5 is recovered by a feeding roller 6 which contacts the developing roller 5. The residual developing agent 8′ on photoreceptor is recovered by roller 2 and blade 10. This process is repeated with each printing cycle.

With the spread of electrophotographic image forming apparatuses such as LBP, multi function products, color copying machines, etc., an image of high quality is required. Thus, an electrophotographic developing agent is designed so as to maintain stable charge quantity and developing efficiency and prevent fog regardless of environmental changes and length of image printing time.

To obtain stable charge quantity of a toner and good developing efficiency and prevent fog, various external additives, such as silica, TiO₂, Al₂O₃, and the like, are added to the toner. However, this method provides a poor image quality. That is, the charge property of a toner significantly changes depending on changes in temperature and humidity and the charge quantity greatly decreases with the passage of time despite initial uniform charge quantity and charge distribution. The image density decreases and fog and scattering of a toner are caused due to a decrease of charge quantity and non-uniform charge distribution when carrying out printing for a long period of time.

Thus, the kind of external additive for improving image quality is increasing and the amount thereof is also gradually increasing. It is preferable for external additives to be stably attached to a toner surface for a long period of time. However, external additives are embedded in or separated from toner particles from toner particles to contaminate the developing member, thereby resulting in an image contamination. The separation increases with the particle size of the external additives. The cohesion between external additives and the particles have recently became a serious problem due to increases in the particle size and the amount of the external additive.

Silica (SiO₂) particulates are generally used as an external additive of a toner and improve developing ability, durability and transfer efficiency. In addition, silica particulates effectively prevent contamination of non-image areas and improve fluidity of the toner particles and the charge properties.

To further improve the above characteristics of silica particulates, the surface of silica particulates are modified through various treatments. Modification of the silica particles to render the surface hydrophobic is usually carried out to improve the frictional charge property. Typically, a hydrophobic functional group such as a siloxane group is introduced to the surface of particulates.

However, when the surface treatment agent of the prior processes are used to modify the surface of silica particulates, fog and blurring occur.

### SUMMARY OF THE INVENTION

The present invention provides an electrophotographic developing agent that maintains stable charge quantity and charge distribution of a toner regardless of environmental changes and length of time image printing is performed. The electrophotographic developing agent of the invention prevents fog and image contamination due to contamination of a developing member by separation of an external additive from the toner particles.

The present invention also provides an electrophotographic image forming apparatus using the developing agent.

According to an aspect of the present invention, there is provided an electrophotographic developing agent including: toner particles including a binder resin, a colorant, and a charge control agent; and an external additive added to the surface of the toner particles, wherein the external additive includes a first large particle diameter silica component having a mean primary particle diameter of 20 to 200 nm and being surface treated with at least two types of surface treatment agent; a second small particle diameter silica component having a mean primary particle diameter of 5 to 20 nm and surface treated with at least two different types of surface treatment agent; and a hydrophobic strontium titanate. The sulfate treatment is preferably a hydrophobic surface treatment where the particles are treated with two different types or classes of hydrophobic agents.

The electrophotographic developing agent according to the present invention includes silcas having a surface treated with at least two types of surface treatment agents as an external additive, thereby maintaining stable charge quantity and charge distribution to prevent fog and blurring. The at least two different types of surface treatment agents are selected from the group consisting of organosilazane compounds, polysiloxane compounds and organofunctional siloxanes.

### BRIEF DESCRIPTION OF THE DRAWING

The above and other features and advantages of the present invention will become more apparent by describing in detail exemplary embodiments thereof with reference to the attached drawing in which:

FIG. 1 is a schematic diagram of a non-contact developing-type electrophotographic apparatus.

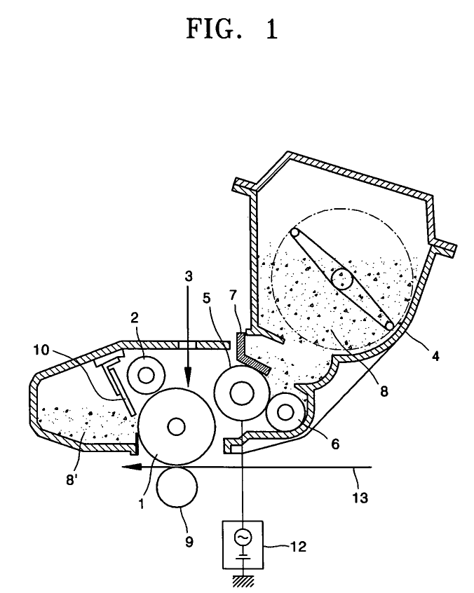

### DETAILED DESCRIPTION OF THE INVENTION

The present invention will now be described in more detail with reference to exemplary embodiments thereof.

The present invention provides an electrophotographic developing agent including: toner particles including a binder resin, a colorant, and a charge control agent; and an external additive added to the surface of the toner particles, wherein the external additive includes a first large particle diameter silica component having a mean primary particle diameter of 20 to 200 nm and being surface treated with at least two types of surface treatment agent; a second small particle diameter silica component having a mean primary particle diameter of 5 to 20 nm and surface treated with at least two types of surface treatment agent; and a hydrophobic strontium titanate. The surface treatment agents are hydrophobic compounds capable of treating the silica particles to render the surface of the silica particles hydrophobic.

In an embodiment of the present invention, the surface treatment agents are preferably at least two materials selected from the group consisting of organosilazane, polysiloxane and an organofunctional siloxane.

The organosilazane is represented by Formula (1):
R₁R₂R₃Si—[NR₄—SiR₁R₂]ₙNR₄—SiR₁R₂R₃ (1)

where each of R₁, R₂, R₃ and R₄ is independently a hydrogen, or a C₁₋₄ alkyl or alkoxy group and n is 0 or an integer of 1 to 3. Preferably, each of R₁, R₂ and R₃ is independently a methyl or ethyl group, R₄ is a hydrogen, and n is 0 or 1.

The polysiloxane is represented by Formula (2):
YSiX₁X₂-(X₁X₂SiO)ₙ—Y (2)

where each of X₁ and X₂ is independently a hydrogen or a C₁₋₄ alkyl group, Y is a C₁₋₄ alkyl group, and n is 0 or an integer of 1 to 100. Preferably, each of X₁ and X₂ is independently a hydrogen, Y is a methyl or ethyl group and n is 0 or an integer of 1 to 100.

The organofunctional siloxane is represented by Formula (3):
Z₁Z₂Z₃—SiO—(H₂SiO)ₙ—SiZ₁Z₂Z₃ (3)

where each of Z₁, Z₂ and Z₃ is independently a hydrogen or a C₁₋₄ alkyl or alkoxy group and n is an integer of 1 to 100. Preferably, each of Z₁, Z₂ and Z₃ is independently a methoxy or ethoxy group and n is an integer of 1 to 100.

In an embodiment of the present invention, the organosilazane is hexamethyldisilazane and the polysiloxane is dimethylpolysiloxane.

In one embodiment of the invention, the silica components having the two different mean particle sizes are treated either simultaneous or sequentially with at least two different types or classes of hydrophobic agents to attach hydrophobic functional groups to the surface of the silica particles. Preferably, the silica particles are treated with at least two hydrophobic treating agents where the at least two hydrophobic treating agents are from different classes or types of hydrophobic treating agents. The different classes or types of hydrophobic treating agents are selected from the group consisting of organosilazane compounds, polysiloxane compounds and organofunctional siloxane compounds.

In the present invention, a dry or wet surface treatment method may be used. For example, silica and surface treatment agents may be dry-blended in a mixer such as Henschel mixer or ballmill. Alternatively, surface treatment agents may be mixed with silica after being dissolved in an appropriate solvent which is removed after mixing.

For a general polymerizing and pulverizing toner, a colorant, a charge control agent, a release agent, and the like, are uniformly added to a binder resin to improve chromaticity, charge characteristics, and fusing properties. Various external additives are further added to provide the toner with fluidity, charge stability, and cleaning property. When adding the external additives, at least two types of external additives having different mean particle diameters can be used together to prevent the external additives from separating from the surface of the toner particles and embedding therein.

The two types of inorganic particulates can be a first large particle diameter silica component having a mean particle diameter of 20 to 200 nm and a small particle diameter silica having a mean particle diameter of 5 to 20 nm. When silicas having different particle diameters are used, the large particle diameter silica acts as spacers that prevent deterioration of the toner and improve a transfer property, and the small particle diameter silica mainly provides the toner with fluidity.

The amount of each of the large particle diameter silica component and the small particle diameter silica component is 0.1 to 3.0 parts by weight based on 100 parts by weight of parent toner particles. When the amount of silica is less than 0.1 part by weight, it is difficult to obtain the desired effects by the addition of silica. When the amount of silica is greater than 3.0 parts by weight, fusing property and cleaning property are poor and overcharge occurs.

The large particle diameter silica component or the small particle diameter silica component can be surface treated using at least two surface treatment agents selected from the group consisting of the materials represented by Formulas (1) through (3). In one embodiment, the silicas can be surface treated with hexamethyldisilazane (HMDS) and dimethylpolysiloxane (DMPS). When the surface treated silicas are used as an external additive, stable charge quantity and charge distribution of a toner can be maintained in spite of environmental changes and long printing time.

The use of only silica with a relatively large specific surface area and small particle size provides a good transfer efficiency, but may result in contamination of a drum at high output for a long period of time. Thus, for the purpose of remarkable improved effects, other inorganic particulates in addition to silica can be used. The inorganic particulate may be at least one material selected from the group consisting of hydrophobic strontium titanate, aluminum oxide, zinc oxide, magnesium oxide, cerium oxide, iron oxide, copper oxide, and tin oxide. In one preferred embodiment, hydrophobic strontium titanate is used.

The hydrophobic strontium titanate used in the present invention can improve the fluidity of the toner and maintain a high transfer efficiency even at high output for a long period of time. Further, the hydrophobic strontium titanate prevents contamination of the drum to improve environmental stability. In particular, the hydrophobic strontium titanate can also prevent charge up of a toner at low temperature and low humidity and charge down of a toner at high temperature and high humidity. Preferably, the hydrophobic strontium titanate has a mean primary particle diameter of 10 to 500 nm, and more preferably 10 to 100 nm. A mean primary particle diameter of the hydrophobic strontium titanate greater than 500 nm causes the charge down of a toner at high temperature and high humidity. A mean primary particle diameter of the hydrophobic strontium titanate less than 10 nm causes poor fusing property and non-uniform charge properties.

The amount of the hydrophobic strontium titanate can vary according to the amount of the two types of silica components. Preferably, the amount of hydrophobic strontium titanate is 0.1 to 2.0 parts by weight, more preferably 0.1 to 1.5 parts by weight, based on 100 parts by weight of parent toner particles. When the amount of the hydrophobic strontium titanate is less than 0.1 parts by weight based on 100 parts by weight of parent toner particles, drum contamination can occur causing image contamination. When the amount of the hydrophobic strontium titanate is greater than 2.0 parts by weight, the desired image cannot be obtained due to a poor friction charge property.

In another embodiment of the present invention, polymer beads can be used in the preparation of an electrophotographic developing agent. The polymer beads are used to prevent an image contamination due to contamination of a developing member.

Preferred polymer beads are melamine-based beads and polymethylmethacrylate (PMMA) beads and they can be used alone or in a combination. A mean particle size of the polymer beads is preferably 0.1 to 3 μm, and more preferably 0.2 to 2 μm. When the mean particle size of the polymer beads is less than 0.1 μm, it is difficult to obtain the desired effect. When the mean particle size of the polymer beads is greater than 3 μm, they easily separate from the toner, and thus, are not preferable.

The amount of the polymer beads is preferably 0.1 to 2.0 parts by weight based on 100 parts by weight of parent toner particles. When the amount of the polymer beads is less than 0.1 part by weight, it is difficult to obtain the desired effect. When the amount of the polymer beads exceeds 2.0 parts by weight, they easily separate from a toner and agglomerate, and thus, are not preferable.

The parent toner particles include a binder resin, a colorant, a charge control agent, and a release agent.

Various conventional resins can be used as a binder resin of the developing agent according to an embodiment of the present invention. The resin can be a styrene copolymer such as a polystyrene, a poly-P-chlorostyrene, a poly-α-methylstyrene, a styrene-chlorostyrene copolymer, a styrene-propylene copolymer, a styrene-vinyltoluene copolymer, a styrene-vinylnaphthalene copolymer, a styrene-acrylic acid methyl copolymer, a styrene-acrylic acid ethyl copolymer, a styrene-acrylic acid propyl copolymer, a styrene-acrylic acid butyl copolymer, a styrene-acrylic acid octyl copolymer, a styrene-methacrylic acid methyl copolymer, a styrene-methacrylic acid ethyl copolymer, a styrene-methacrylic acid propyl copolymer, a styrene-methacrylic acid butyl copolymer, a styrene-a-chloromethacrylic acid methyl copolymer, a styrene-acrylonitrile copolymer, a styrene-vinylmethylether copolymer, a styrene-vinylethylether copolymer, a styrene-vinylethylketone copolymer, a styrene-butadiene copolymer, a styrene-acrylonitrile-inden copolymer, a styrene-maleic acid copolymer, a styrene-maleic acid ester copolymer, etc., a polymethylmethacrylate, a polyethylmethacrylate, a polybutylmethacrylate, and their copolymers, a polyvinyl chloride, a polyvinyl acetate, a polyethylene, a polypropylene, a polyester, a polyurethane, a polyamide, an epoxy resin, a polyvinylbutyral resin, a rosin, a denatured rosin, a terpene resin, a phenol resin, an aliphatic or alicyclic hydrocarbon resin, an aromatic petroleum resin, a chlorinated resin, a paraffin wax, etc., or combinations thereof. The polyester resin is suitable for a color-developing agent due to its superior fusing property and transparency.

The developing agent according to an embodiment of the present invention can further comprise a colorant. For a black and white toner, carbon black or aniline black can be used as a colorant. A non-magnetic color toner can be easily prepared according to an embodiment of the present invention. Also, for a color toner, carbon black is used as a black colorant. Yellow, magenta and cyan colorants can also be used as colorants.

The yellow colorant can be a condensed nitrogen compound, an isoindolinone compound, an anthraquinone compound, an azo metal complex or an allyl amide compound. Specifically, C.I. pigment yellow 12, 13, 14, 17, 62, 74, 83, 93, 94, 95, 109, 110, 111, 128, 129, 147 or 168, etc. can be used.

The magenta colorant can be a condensed nitrogen compound, an anthraquinone compound, a quinacridone compound, a basic dye lake compound, a naphthol compound, a benzoimidazole compound, a thioindigo compound or a perylene compound. Specifically, C.I. pigment red 2, 3, 5, 6, 7, 23, 48:2, 48:3, 48:4, 57:1, 81:1, 144, 146, 166, 169, 177, 184, 185, 202, 206, 220, 221 or 254, etc., can be used.

The cyan colorant can be a copper phthalocyanine and its derivative, an anthraquinone compound or a basic dye lake compound. Specifically, C.I. pigment blue 1, 7, 15, 15:1, 15:2, 15:3, 15:4, 60, 62 or 66, etc. can be used.

The colorant can be used alone or as a mixture of at least two types of colorants. The colorants can be selected in consideration of color, saturation, brightness, durability, dispersibility in a toner, and the like.

The amount of the colorant is sufficient to form a visible image by development, and can be 2 to 20 parts by weight based on 100 parts by weight of a binder resin. When less than 2 parts by weight of the colorant is used, the colorizing effects are insufficient. When the amount of colorant exceeds 20 parts by weight, the electrical resistance becomes low, so that sufficient frictional charge cannot be obtained, thereby creating a danger of contamination.

The charge control agent can be a negative charge control agent or a positive charge control agent, and the negative charge control agent can be an organic metal complex such as a chromium-containing azo dye or a monoazo metal complex, or a chelate compound; a salicylic acid compound containing metals such as chromium, iron and zinc; or an organic metal complex such as aromatic hydroxycarboxylic acid and aromatic dicarboxylic acid, although the charge control agent is not limited to these. The positive charge control agent can be a product modified with nigrosine and its fatty acid metal salt, etc.; an onium salt comprising a quaternary ammonium salt such as tributylbenzylammonium 1-hydroxy4-naphthosulfonate and tetrabutylammonium tetrafluoroborate; or a combination thereof. The charge control agents support toner on the developing roller by electrostatic force in a stable manner, and thus, stable and rapid charging can be obtained.

The amount of the charge control agent in the toner composition is generally 0.1 to 10% by weight based on 100% by weight of the whole toner particles.

The toner particles according to an embodiment of the present invention can further comprise a release agent, a higher fatty acid, and its metal salt. The release agent can be a polyalkylene wax such as low molecular weight polypropylene, low molecular weight polyethylene, and the like, an ester wax, a carnauba wax, a paraffin wax, a higher fatty acid, a fatty acid amide, and the like. The higher fatty acid and its metal salt can be added to protect the photoreceptor and prevent deterioration of the developing property, thereby maintaining high image quality.

The colorant can be previously flushed to uniformly disperse in the binder resin or a master batch of the colorant and the binder resin melt-kneaded in high concentration can be used. For example, the binder resin and the colorant can be mixed by a kneading means, such as a 2-roll, 3-roll, and pressure type kneader, or twin-screw extruder. At this time, the colorant should be uniformly dispersed and is melt-kneaded at 80-180° C. for 10 min to 2 hr. Then, the mixture is finely pulverized using a pulverizer, such as a jet mill, an attritor mill, or a rotatory mill to obtain toner particles having a mean particle diameter of 3-15 μm. The external additives are attached to the obtained toner particles to improve fluidity and charge stability.

The developing agent according to an embodiment of the present invention can also be prepared by a polymerization method as well as a melt-kneading pulverizing method. To attach the external additives to toner particles, the toner particles and the external additives were combined in a desired ratio, and the mixture was filled in an agitator such as HENSCHEL mixer and stirred so that the external additives could attach to the surface of the toner particles. In another experiment, both particles were mixed with a surface modifier such as ‘NARA HYBRIDIZER’ and stirred so that the external additives could attach to the toner particles by being at least partly embedded into the surface of the toner particles.

The developing agent according to an embodiment of the present invention can also be applied to a toner of a non-magnetic one-constituent contact-type developing method as well as to the electrophotographic apparatus using a non-contact non-magnetic one-constituent toner. The developing agent can also be applied to both a negatively charged toner and a positively charged toner.

The present invention also provides an electrophotographic image forming apparatus using an electrophotographic developing agent including: toner particles including a binder resin, a colorant, and a charge control agent; and an external additive added to the surface of the toner particles, wherein the external additive includes a large particle diameter silica component having a mean primary particle diameter of 20 to 200 nm and being surface treated with at least two different types of surface treatment agent; a small particle diameter silica component having a mean primary particle diameter of 5 to 20 nm and surface treated with at least two types of surface treatment agent; and a hydrophobic strontium titanate having a particle diameter of 500 nm or less.

The present invention will now be described in greater detail with reference to the examples. The following examples are for illustrative purposes only and are not intended to limit the scope of the invention.

### EXAMPLES

### Preparation of Toner Particles

The amount of the materials used is expressed in parts by weight based on 100 parts by weight of untreated parent toner particles.

90.5 parts by weight of polyester having a weight-average molecular weight of 100,000, 5 parts by weight of carbon black (manufactured by Mitsubishi Chemical Co.), 2.5 parts by weight of a negative charge control agent (manufactured by Hodogaya, Fe complex) and 2 parts by weight of a low molecular weight polypropylene wax (manufactured by Sanyo Chemical Industry Co.) were pre-mixed using a HENSCHEL mixer. Then, the mixture was infused into a twin screw extruder and a melted mixture was extruded at 130° C. and cooled to coagulate. Then, an untreated toner with a mean particle diameter of about 8 μm was obtained using a grinding classifier.

### Example 1

Hexamethyldisilazane (HMDS), dimethlylpolysiloxane (DMPS) and silica particles were mixed in HENSCHEL mixer and stirred for 5 min to treat the surface of silica particles. Then, a toner was prepared by adding the following external additives to untreated toner prepared by the pulverizing method.

External Additives:

Large particle diameter silica surface-treated with HMDS and DMPS (mean primary particle diameter: 30 to 50 nm)=1.0 part by weight

Small particle diameter silica surface-treated with HMDS and DMPS (mean primary particle diameter: 7 to 16 nm)=1.0 part by weight

Strontium titanate (mean primary particle diameter: 10 to 50 nm)=0.5 part by weight

Melamine beads (mean primary particle diameter: 300 to 500 nm)=0.5 part by weight.

### Comparative Example 1

A toner was prepared by adding the following external additives to untreated toner prepared by the pulverizing method.

External Additives:

Large particle diameter silica surface-treated with HMDS (mean primary particle diameter: 30 to 50 nm)=1.0 part by weight

Small particle diameter silica surface-treated with HMDS (mean primary particle diameter: 7 to 16 nm)=1.0 part by weight

Strontium titanate (mean primary particle diameter: 10 to 50 nm)=0.5 part by weight.

### Comparative Example 2

A toner was prepared by adding the following external additives to untreated toner prepared by the pulverizing method.

External Additives:

Large particle diameter silica surface-treated with HMDS (mean primary particle diameter: 30 to 50 nm)=1.0 part by weight

Small particle diameter silica surface-treated with HMDS and DMPS (mean primary particle diameter: 7 to 16 nm)=1.2 part by weight

Strontium titanate (mean primary particle diameter: 10 to 50 nm)=0.5 part by weight

Melamine beads (mean primary particle diameter: 300 to 500 nm)=0.5 part by weight.

### Comparative Example 3

A toner was prepared by adding the following external additives to untreated toner prepared by the pulverizing method.

External Additives:

Large particle diameter silica surface-treated with HMDS and DMPS (mean primary particle diameter: 30 to 50 nm)=1.0 part by weight

Small particle diameter silica surface-treated with HMDS (mean primary particle diameter: 7 to 16 nm)=1.0 part by weight

Strontium titanate (mean primary particle diameter: 10 to 50 nm)=0.5 part by weight

Melamine beads (mean primary particle diameter: 300 to 500 nm)=0.5 part by weight.

### Image Evaluation Test (Based on Negatively Charged Toner)

Surface electric potential (V₀): −700 V

Latent image electric potential (VL): −100 V

Voltage applied to developing roller:
Vp-p=1.8 KV, frequency=2.0 kHz,
Vdc=−500V, efficiency ratio=35% (spherical wave)

Developing gap: 150 to 400 μm

Developing roller:
(1) For aluminum intensity of illumination: Rz=1-2.5 (after doping with nickel)
(2) For rubber roller (NBR-based elastic rubber roller)
   resistance: 1×10⁵-5×10⁶ Ω
   hardness: 50

Toner: charge per mass (q/m)=−5 to −30 μC/g (on developing roller after passing developing agent regulating blade)
mass of toner per area (m/a)=0.3 to 1.0 mg/cm²

### Image Evaluation Result (Based on Negatively Charged Toner)

Images produced using the toners of Example 1 and Comparative Examples 1 to 3 were evaluated using a 20 ppm-grade LBP printer. The images were inspected for image density, fog (background, contamination of non-image area) and blurring of an initial image. The image density was obtained by measuring the density of solid pattern on a paper. The fog was obtained by measuring the density of fog in a non-image area on a photoreceptor using a densitometer (SpectroEye, manufactured by Gretag Macbeth Co.). The blurring of an initial image was evaluated with the naked eye.

TABLE 1
Image density

| | Initial | 1,000 | 2,000 | 3,000 | 4,000 | 5,000 |
|---|---|---|---|---|---|---|
| Example 1 | ◯ | ◯ | ◯ | ◯ | ◯ | Δ |
| Comparative | ◯ | ◯ | ◯ | ◯ | Δ | Δ |
| Example 1 | | | | | | |
| Comparative | ◯ | ◯ | ◯ | ◯ | Δ | Δ |
| Example 2 | | | | | | |
| Comparative | ◯ | ◯ | ◯ | ◯ | Δ | Δ |
| Example 3 | | | | | | |

TABLE 2
Fog

| | Initial | 1,000 | 2,000 | 3,000 | 4,000 | 5,000 |
|---|---|---|---|---|---|---|
| Example 1 | ◯ | ◯ | ◯ | ◯ | ◯ | Δ |
| Comparative | ◯ | ◯ | ◯ | Δ | X | X |
| Example 1 | | | | | | |
| Comparative | ◯ | ◯ | ◯ | Δ | X | X |
| Example 2 | | | | | | |
| Comparative | ◯ | ◯ | ◯ | Δ | Δ | X |
| Example 3 | | | | | | |

TABLE 3
Blur

| | Initial image |
|---|---|
| Example 1 | ◯ |
| Comparative Example 1 | X |
| Comparative Example 2 | Δ |
| Comparative Example 3 | Δ |

### Basis for Evaluation

In Table 1 above, the image density evaluation results are indicated as “◯” when greater than 1.3, as “Δ” when between 1.1 and 1.3, and as “X” when less than 1.1.

In Table 2 above, the fog evaluation results are indicated as “◯” when less than 0.14, as “Δ” when between 0.15 and 0.16, and as “X” when greater than 0.17.

In Table 3 above, the blurring evaluation results are indicated as “◯” when blurring did not occur and as “X” when serious blurring occurred.

As can be seen from the results, the toner of Example 1 having the large particle diameter silica and the small particle diameter silica, both treated with HMDS and DMPS has improved image density, fog and blurring. The toner of Comparative Example 1 having the large particle diameter silica and the small particle diameter silica, both treated with only HMDS causes fog at the number of paper increases and has blurring problems. The toner of Comparative Example 2 having the small particle diameter silica treated with HMDS and DMPS seriously causes fog and the toner of Comparative Example 3 having the large particle diameter silica treated with HMDS and DMPS causes fog which is less serious than Comparative Example 2.

The developing agent according to an embodiment of the present invention includes silica surface-treated with at least two different types of surface treatment agents as an external additive to prevent fog and blurring and can be usefully used in various electrophotographic image forming apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic developing agent comprising:
toner particles comprising a binder resin, a colorant, and a charge control agent; and
an external additive added to the surface of the toner particles,
wherein the external additive comprises a large particle diameter silica component having a mean primary particle diameter of 20 to 200 nm and surface treated with at least two different types of surface treatment agents; a small particle diameter silica component having a mean primary particle diameter of 5 to 20 nm and surface treated with at least two different types of surface treatment agent; and a hydrophobic strontium titanate.

2. The electrophotographic developing agent of claim 1, wherein said surface treatment agents are hydrophobic agents.

3. The electrophotographic developing agent of claim 1, wherein the at least two different types of surface treatment agents are selected from the group consisting of organosilazanes, polysiloxanes and organofunctional siloxanes.

4. The electrophotographic developing agent of claim 3, wherein the organosilazane is represented by Formula (1):
R₁R₂R₃Si—[NR₄—SiR₁R₂]ₙNR₄—SiR₁R₂R₃ (1)
where each of R₁, R₂, R₃ and R₄ is independently a hydrogen, or a C₁₋₄ alkyl or alkoxy group and n is 0 or an integer from 1 to 3.

5. The electrophotographic developing agent of claim 4, wherein each of R₁, R₂ and R₃ is independently a methyl or ethyl group, R₄ is a hydrogen, and n is 0 or 1.

6. The electrophotographic developing agent of claim 3, wherein the polysiloxane is represented by Formula (2):
YSiX₁X₂-(X₁X₂SiO)ₙ—Y (2)
where each of X₁ and X₂ is independently a hydrogen or a C₁₋₄ alkyl group,
Y is a C₁₋₄ alkyl group, and
n is 0 or an integer from 1 to 100.

7. The electrophotographic developing agent of claim 6, wherein each of X₁ and X₂ is independently a hydrogen, Y is a methyl or ethyl group, and n is 0 or an integer from 1 to 100.

8. The electrophotographic developing agent of claim 3, wherein the organofunctional siloxane is represented by Formula (3):
Z₁Z₂Z₃—SiO—(H₂SiO)ₙ—SiZ₁Z₂Z₃ (3)
where each of Z₁, Z₂ and Z₃ is independently a hydrogen or a C₁₋₄ alkyl or alkoxy group and n is an integer from 1 to 100.

9. The electrophotographic developing agent of claim 8, wherein each of Z₁, Z₂ and Z₃ is independently a methoxy or ethoxy group and n is an integer from 1 to 100.

10. The electrophotographic developing agent of claim 3, wherein the organosilazane is hexamethyldisilazane and the polysiloxane is dimethylpolysiloxane.

11. The electrophotographic developing agent of claim 1, wherein the amount of each of the large particle diameter silica and the small particle diameter silica is 0.1 to 3.0 parts by weight based on 100 parts by weight of toner particles.

12. The electrophotographic developing agent of claim 1, wherein the hydrophobic strontium titanate has a mean particle diameter of 10 to 500 nm.

13. The electrophotographic developing agent of claim 1, wherein the amount of the hydrophobic strontium titanate is 0.1 to 2.0 parts by weight based on 100 parts by weight of toner particles.

14. The electrophotographic developing agent of claim 1, further comprising polymer beads.

15. The electrophotographic developing agent of claim 14, wherein the polymer beads are melamine-based beads or polymethylmethacrylate beads.

16. The electrophotographic developing agent of claim 14, wherein the polymer beads have a mean particle diameter of 0.1 to 3 μm.

17. The electrophotographic developing agent of claim 14, wherein the amount of the polymer beads is 0.1 to 2.0 parts by weight based on 100 parts by weight of toner particles.

18. An electrophotographic image forming apparatus using the electrophotographic developing agent of claim 1.
